(19) United States
(12) Patent Application Publication
(10) Pub. No.: US 2011/0019240 A1
(43) Pub. Date: Jan. 27, 2011

(54) Digital control and processing of transferred Information

(75) Inventor: Scott C. Harris, Rancho Santa Fe, CA (US)

Correspondence Address: SCOTT C HARRIS;Law Office of Scott C Harris, Inc, P O BOX 1389, Rancho Santa Fe, CA, 92067-1389, US

(73) Assignee: HARRIS TECHNOLOGY, LLC, Rancho Santa Fe, CA (US)

(21) Appl. No.: 12/506,812

(22) Filed: Jul. 21, 2009

(51) Int. Cl. H04N 1/00

(52) U.S. Cl. 358/403

(57) ABSTRACT

Access control for documents, that uses a computer to first check an access control of the document, and allow the specified access to the document only if the access control indicates that the specified access should be granted. After granting the specified access, the access control is changed to indicate that the specified access has been granted, for example, by incrementing a counter or the like.

### BACKGROUND

When documents were primarily on paper, such a document might be written on paper, and read by a user. There have been different ways of maintaining confidentiality of such a document. For example, a user could be allowed to read the document but not physically take it. A user could be given an original document, with certain markings on the document, make a promise not to copy, and a promise to shred or return the document when they were finished.

### SUMMARY

The present inventor recognized problems in the electronic formation and/or use and/or accessing of documents. These problems and issues are wholly different than any analogous actions that occurred in interaction with paper documents.

Even in the paper medium, there is no real way to enforce the restrictions, since a user can copy the document, and no one has any way of knowing that. However, watermarks, stamps, etc, could be used to attempt to show that a document is a copy.

The copying can be even easier, and harder to stop, in electronic media. When you send an electronic version of a document to a user, that document can be copied.

Accordingly, the present application describes electronically watermarking documents, and automatically determining permission information for these documents, e.g., keep, destroy and shred, for example.

### BRIEF DESCRIPTION OF THE DRAWINGS

FIG. 1 shows an embodiment that forms, marks and uses a document; and

FIG. 2 shows a progression of document versions.

### DETAILED DESCRIPTION

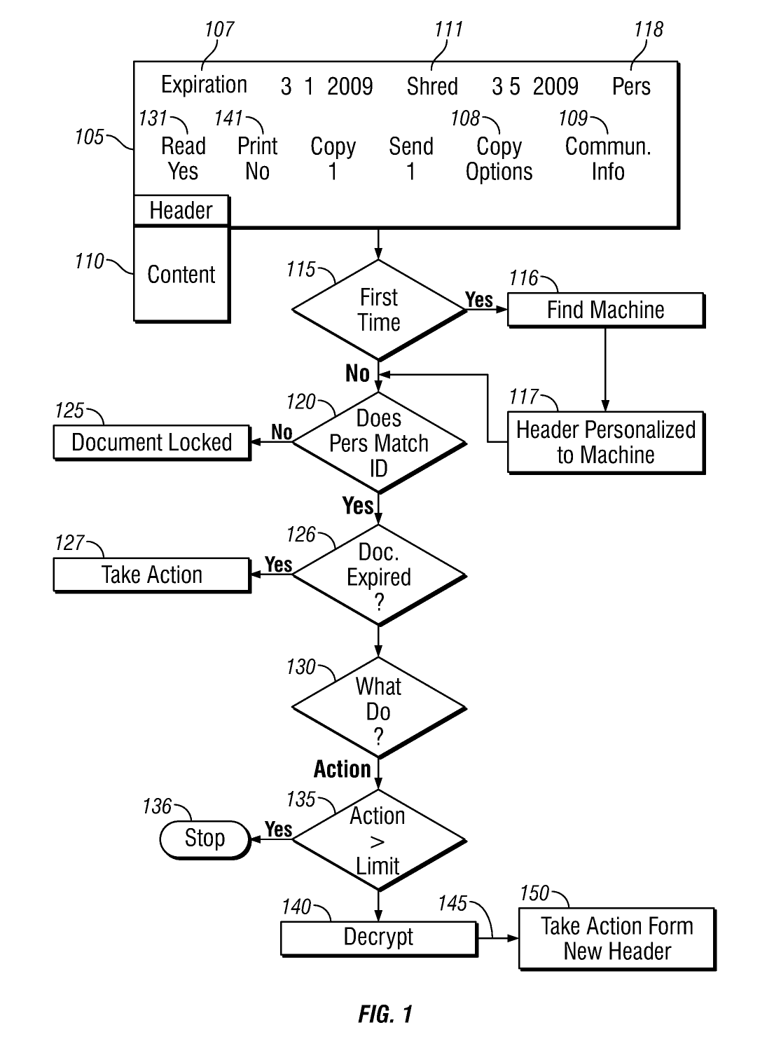

FIG. 1 illustrates a basic embodiment, where a document, 100 is formed with a control portion 105, e.g. a control information, and content 110. The control portion can be anywhere in the document, and in one embodiment, is preferably mirrored in multiple places throughout the document.

The content is read under control of, or with cooperation of, the control information 105.

In one embodiment, the control information may include simple control instructions. Other embodiments, however, may provide additional details about what constitutes authorized operations. For example, in one embodiment, the content 110 of the document may be encrypted. The control information 105 includes the decryption information for reading the content 110. However, the control information 105 only allows the decryption information to be used for the decrypting according to certain rules that define access to the document.

Another embodiment describes forming these documents. In this embodiment, the date and time of the formation can be used as part of the encrypting. For example, this can use a cryptographic “token” technique. In a “token” technique, there may be hardware or software that can be part of the machine that carries out the formation. The token has a secret internal key that encrypts information using either a current date and time, or a date/time of the encryption, as part of its operation. The date and time of the creation of the original document (or encryption) can therefore be made into part of the decryption. This becomes part of the encryption operation.

In one embodiment, the control information is an executable file which decrypts or otherwise reads the document.

In one embodiment, the document may be in a proprietary format that can only be read by a reader of a type which is specified in the control information. Since the reader is read-only (that is, in one embodiment, does not have the capability to edit), it can be a small in size program, and not take up much room in the file. By including the reading program as part of the document, the reading program itself can enforce the rules described herein.

People may be concerned about viruses etc in such a file which is actually executed. In one embodiment, the reading program may be an executable, but may include security details that specify the safety of the executable, for example, a security certificate that indicates that the executable is safe to execute.

The operation of reading the file is shown in FIG. 1. At 115, a document has been selected for reading, and the data in the header 105 is used to determine if this is the first time reading the document at 115, by seeing if personalization information 118 has been written. If the reading program recognizes that the document has not yet been personalized, this means that no information has been added to the document about previous or current access to the document. Hence, the flowchart passes control in the “yes” direction, which runs the first time routine. At 116, this finds automatically information about the machine on which the document is resident. Different machine specific information can be used for this routine. For example this may use a processor ID number, or a serial number of any other hardware within the machine. In one embodiment, this may use the serial number of a storage device on which the document is residing.

At 117, the control information 105 or “header” is personalized to that machine, so that document can determine that it was 1) made on that machine, and/or 2), if desired, can only be executed on that machine. Another embodiment may allow any machine to read the document, in that case, the personalization information may be disabled. Other embodiments may allow some reading and/or actions on another machines, but not unlimited.

Once personalized at 117, or if the control information has already been detected to be personalized at 115, access to the document proceeds. The access first determines if the personalization 118 matches the ID at 120. The matching of the personalization may not require a machine-by-machine match—for example, as described above, the personalization may allow other machines access to the document according to the rules (e.g., once a day), or the personalization might only allow access by the specific machine.

If the personalization does not match the ID at 120, the document is locked against further use at 125. The locking against further use may later be unlocked using a special ID code that may be a secret code. The locking prevents viewing a document which has been moved from one computer to another.

In another embodiment, the locking allows the document to be viewed on any single computer but not on other computers. For example, this may personalize the document according to the computer information, or personalize the document with the computer information the first time it is used (using the computer information on which it was used).

If the personalization does match the ID at 120, the program determines at 126 if the document has expired. For example, if a document has expired, it may include an expiration date in the control information, e.g, shown as 107. Once 126 detects that the expiration date has passed, 127 takes an action on the document. The action that is taken may be as stated in the control information. The action for example may provide a warning and wait another time period for the document to be renewed, limit the functionality of the document, or take some other actions. In another embodiment, the expiration may digitally shred the document, by using a shred program which finds all bits forming the document, and writes over each of those bits, either once, or many times. For example, this may write over the bits 128 times, using random bits, or using all 0s then all 1s. It can, of course, write over the bits some other number of times, e.g, 10 times, 64 times, or any other amount of times.

If the document is not expired at 126, the program queries for the user's next desired action at 130. Different options may be available for different documents, depending on the content of the control information. For example, the control information may specify that the document can be read but cannot be printed. The control information can specify that the document can be copied once and sent once. Many different things that can be done with a document may be specified by this control information. In embodiments, as shown herein, the control information constrains what can be done by the reading and/or editing program.

One embodiment sets these rules, and allows decrypting at 140 only if these rules have been met.

In another embodiment, the control information makes rules that need to be enforced by any program. The digital millennium copyright act defines that intentional violation of copy protection is illegal. Hence, by specifying the kinds of actions that can be taken on the file, this constrains the program to take only those actions.

As described above, actions such as reading, print, send, copy, etc., are enabled by the control information shown as 106 within the header 105. The user is allowed to take these actions on the document according to these parameters at 130.

The action first checks at 135 to determine whether the action limit, e.g, copy limit, read limit, send limit, copy limit, etc has already been reached. If the limit has been reached, the process stops at 136. If not, the document can be decrypted at 140, if decryption is used in the specific embodiment

For any of these operations, the document can be decrypted at 140, and the action taken at 145. After the action has been taken on the document, a new header for the document is formed with the new information at 150. This can indicate, for example, the number of prints, copies, reads or sends being greater than a predetermined amount. Any of these features form new control information indicating the action which has been taken.

When a document copy has been made, for example, the copy will be made with new control information at 145. That document includes information indicating that it is a copy, and based on instructions 108 in the old control information, includes information about the capabilities of that copy.

Note that the copy will not have personalization information 118 when first made, so the “first time routine” will be run the first time that the copy is run on another machine.

Default instructions can also be used to determine how to handle any document for which specific instructions were not made. For, example, if a “copy” command is carried out without specific instructions on what to do with a copy command, a document just like the original document may be made, however indicating that it is a copy, and incrementing the total number of “copies made” variable in both the original document and the copy.

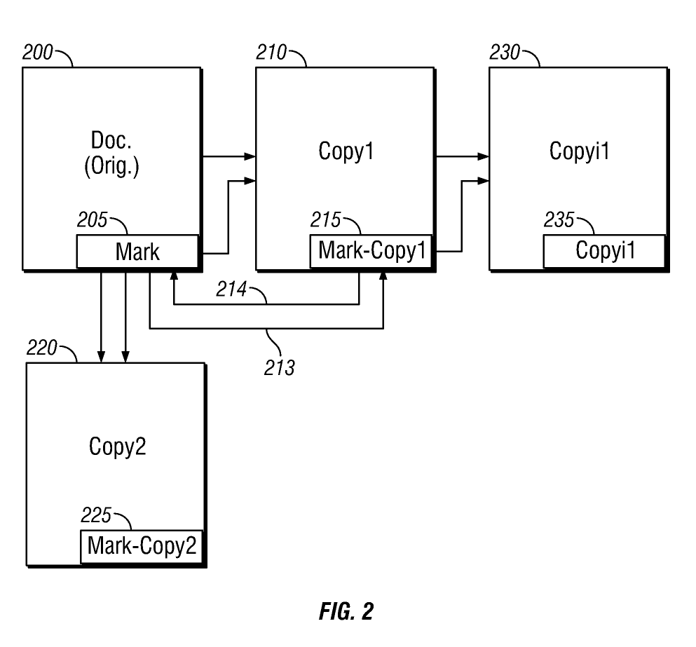

FIG. 2 illustrates how electronic version of the documents can be formed as originals, copies of the originals, copies of copies, or multiple different copies of the originals.

The original document 200 is shown with its mark 205, where the mark can be the marks a header file 105 shown in FIG. 1. Making a copy of this document uses the rules in the header 105 to form a copy 210 with its own new header 215. As shown, the header 215 shows that the copy is in fact copy number 1 of the document. Subsequently, another copy of the document can be made as copy 220. In this case, its header shows that this is copy 2. The original header 205 has been modified when the first copy was made, so that the second copy can be marked as a second copy. In a similar way, a copy can be copied (assuming this is allowed by the control information), to form copy I1, that is the first copy of a copy. This changes header 215, and also has its own header 235 indicating that it is a copy of a copy.

In one embodiment, the original header 205 might not have information about a copy of the copy. In another embodiment, however, the original document includes communication information shown as 109 in its control information. In this embodiment, when a copy of a copy is made, that information may be sent shown is 214 to modify the original header. For example, the sending may be by e-mail, or may use any other form of information sending.

In another embodiment, the reading program requires a “phone home” before action can be taken on the document. The phone home can require a communication to a clearinghouse, or to a specified server, or to the creator of the document. The phone home can be a network connection that verifies that the document can and should be read. In one embodiment, communication to a specified recipient is required before any or certain actions can be taken on the document or only at certain times. For example, it may be required to phone home before copying or printing, but not before reading. The phone home embodiment may require communicating to a remote location to verify the access control, and allowing specified access only after the communication to the remote location has been successful.

The communication embodiment also provides an additional advantage in that when communication is possible between the different documents (for example the different computers holding the documents) then a shred routine can be carried out more effectively. For example, when a user issues a shred command to the original document, that shred command may also cause a header to send a shred command shown as 213 to any document that it has retained communication with. The shred command may add a shred bit to the header 106. In 105. As an alternative while there is the shred it 111 as an alternative, the shred it may simply set all permissions to know, changing the document so that it is no longer possible to view any actions on the document, that is they cannot be read, printed, copied, sent, or anything else.

This also allows the controller to re-set permissions after the document has left their control.

The phone home can use the flowchart of FIG. 1 to determine whether access should be granted.

In another embodiment, the shred routine, leaves the control information 105 intact, but shreds the content of the document. The control information can be sent back.

Another embodiment may allow an administrative password on the header, so that the header can be changed by an authorized person, e.g., to extend the expiration date, or to set a “shred now” option.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, the above contemplates that the documents can be readable and/or editable documents, such as electronic paper substitutes (word processing documents, imaged documents such as PDF or tiffs, etc), more specifically documents that can be read and/or notated. However, the documents can be any electronic file, such as music or video files, read only files or any other kind of file.

Also, the personalization described above can personalize the document for multiple computers, so that the document could be accessed by any of those multiple computers.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the exemplary embodiments of the invention.

The various illustrative logical blocks, modules, and circuits described in connection with the embodiments disclosed herein, may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. These devices may also be used to select values for devices as described herein.

The steps of a method or algorithm described in connection with the embodiments disclosed herein may be embodied directly in hardware, in a software module executed by a processor, or in a combination of the two. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Also, the inventors intend that only those claims which use the words “means for” are intended to be interpreted under 35 USC 112, sixth paragraph. Moreover, no limitations from the specification are intended to be read into any claims, unless those limitations are expressly included in the claims. The computers described herein may be any kind of computer, either general purpose, or some specific purpose computer such as a workstation. The programs may be written in C, or Java, Brew or any other programming language. The programs may be resident on a storage medium, e.g., magnetic or optical, e.g. the computer hard drive, a removable disk or media such as a memory stick or SD media, or other removable medium. The programs may also be run over a network, for example, with a server or other machine sending signals to the local machine, which allows the local machine to carry out the operations described herein.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method of accessing a document, comprising:
using a computer for checking an access control of a document;
allowing a specified access to the document by computer only if the access control indicates that the specified access should be granted; and
after granting said specified access, using the computer for changing information indicative of the access control to changed information indicative of the access control, where said changed information indicates that the specified access has been granted,
wherein checking the access control at a subsequent time checks different information than the access control information at a first time, and where said different information is based on the changed information.

2. A method as in claim 1, wherein said specified access includes reading contents of a document, and said reading contents of said document is allowed only if the access control indicates that a number of times of reading has not been exceeded, and where each time of reading increments a value indicative of a number of times that reading of the document has occurred.

3. A method as in claim 1, wherein said specified access includes copying, where copying is allowed only if the access control indicates that a number of copies that have been made has not been exceeded, and where each copying increments a value indicative of a number of times that copying of the document has occurred.

4. A method as in claim 1, further comprising communicating to a remote location to verify said access control, and allowing specified access only after communication to the remote location is successful.

5. A method as in claim 1, further comprising changing the document in a way such that it cannot be read unless the access control indicates that the specified access should be granted.

6. A method as in claim 1, further comprising controlling an access program in a way such that the access program will not grant the access unless the access control indicates that the specified access should be granted.

7. A method as in claim 1, wherein said access control includes personalizing a document to a specified computer, and allowing access to the document only by the specified computer.

8. A method as in claim 5, wherein said changing comprises encrypting the document.

9. A computer readable medium encoded with a computer program to cause a machine to:
check an access control of a document at a first time;
allow a specified access to the document by a computer only if the access control indicates that the specified access should be granted; and
after granting said specified access, changing information indicative of the access control to changed information indicative of the access control, where said changed information indicates that the specified access has been granted,
at a subsequent time to said first time, check different information than the access control information at the first time, and where said different information is based on the changed information.

10. A medium as in claim 9, wherein said specified access includes reading contents of a document, and said reading contents of said document is allowed only if the access control indicates that a number of times of reading has not been exceeded, and where each time of reading increments a value indicative of a number of times that reading of the document has occurred.

11. A medium as in claim 9, wherein said specified access includes copying, where copying is allowed only if the access control indicates that a number of copies that have been made has not been exceeded, and where each copying increments a value indicative of a number of times that copying of the document has occurred.

12. A medium as in claim 9, further comprising communicating to a remote location to verify said access control, and allowing specified access only after communication to the remote location is successful.

13. A medium as in claim 9, further comprising controlling an access program in a way such that the access program will not grant the access unless the access control indicates that the specified access should be granted.

14. A medium as in claim 9, wherein said access control includes personalizing a document to a specified computer, and allowing access to the document only by the specified computer.

16. A medium as in claim 5, wherein said changing comprises encrypting the document.

17. A method of accessing a document, comprising:
using a computer for checking an access control of a document by determining access control information in the document and comparing said access control information to determine if the access control information refers to said computer which is checking the access control;
allowing a specified access to the document by said computer only if the access control information refers to said computer which is checking the access control.

18. A method as in claim 17, further comprising, after granting said specified access, using the computer for changing information indicative of the access control to changed information indicative of the access control, where said changed information indicates that the specified access has been granted.

19. A method as in claim 17, wherein said specified access includes reading contents of a document, and said reading contents of said document is allowed only if the access control indicates that a number of times of reading has not been exceeded, and where each time of reading increments a value indicative of a number of times that reading of the document has occurred.

20. A method of accessing a document, comprising:
using a computer for checking an access control of a document, by determining information about the document, connecting to a remote location and communicating said information, and allowing a specified access to the document by the computer only if a communication from the remote location indicates that the specified access should be granted.

21. A method as in claim 21, further comprising, after granting said specified access, using the computer for changing information indicative of the access control to changed information indicative of the access control, where said changed information indicates that the specified access has been granted,
wherein checking the access control at a subsequent time checks different information than the access control information at a first time, and where said different information is based on the changed information.
